(19) United States
(12) Patent Application Publication
(10) Pub. No.: US 2008/0298883 A1
(43) Pub. Date: Dec. 4, 2008

(54) Ring Binder Kit and Fastening System

(75) Inventor: Hung Yu Cheng, Hong Kong (CN)

Correspondence Address: SENNIGER POWERS LLP, 100 NORTH BROADWAY, 17TH FLOOR, ST LOUIS, MO, 63102, US

(73) Assignee: WORLD WIDE STATIONERY MFG. CO., LTD., Hong Kong (CN)

(21) Appl. No.: 11/754,538

(22) Filed: May 29, 2007

(51) Int. Cl. B42F 3/00

(52) U.S. Cl. 402/70; 402/75

(57) ABSTRACT

A fastening system for securing a ring mechanism on a substrate has a tubular support post, an expansible retainer, and a generally pin-shaped expansion member. The tubular support post has a sidewall with an inner surface defining a central passage through the support post. The expansible retainer has a head portion with a hole therethrough, and at least two flexible fingers extending longitudinally from the head portion. The flexible fingers collectively have an inner surface that together with the hole defines a central passage extending through the expansible retainer and have a cross-sectional dimension. The expansion member has a cross-section that is greater than the cross-sectional dimension of at least a portion of the central passage of the expansible retainer to urge and retain the flexible fingers transversely outward from a relaxed condition to a deflected condition in engagement with the sidewall of the support post.

### FIELD OF THE INVENTION

This invention relates to fastening systems for joining a ring mechanism to a cover or other substrate, and more particularly to a ring binder kit in which a fastening system may be used to join a ring mechanism to a cover or other substrate.

### BACKGROUND

Conventional ring binders are made by securing a ring mechanism to a cover using rivets. Commonly, ring mechanisms include a housing and a plurality of ring members attached to the housing for retaining loose-leaf pages such as hole-punched pages. Typically, the ring mechanism is secured to the cover by inserting the rivets through the cover and openings in the ring mechanism. The tail of each of the rivets is then deformed (e.g., by punching) to engage and fasten the ring mechanism. Once assembled, the ring binder is packaged and shipped to a distributor, a retailer, or directly to an end user (e.g., a consumer).

One of the drawbacks of traditional ring binders relates to their shipping and storage after they are assembled. When assembled, large gaps exist between the ring mechanism and the cover for each ring binder, thereby leaving large amounts of room unused during shipping and storing of multiple ring binders. The number of ring binders loaded into each package is thus greatly limited. As a result, packaging and shipping conventional ring binders is inefficient, which results in significant shipping and handling costs. Moreover, even a limited number of ring binders occupy a substantial amount of storage space or retail display space.

Efforts to overcome some of the shortcomings of conventional ring binders have been disclosed in coassigned U.S. Pat. Nos. 5,924,811 to To et al.; 5,879,097 to Cheng; and 5,160,209 to Schuessler, all of which are hereby incorporated by reference in their entireties.

### SUMMARY

In one aspect, a ring binder kit generally comprises a substrate having an aperture therein and a ring mechanism comprising a housing and two or more rings. Each ring comprises a first ring member and a second ring member and is configurable between a closed configuration in which the ring members together form a closed loop and an opened configuration in which the ring members are spaced from each other. A fastening system is configured to secure the ring mechanism to the substrate.

The fastening system comprises a tubular support post mounted on and extending at least in part through the ring mechanism housing and at least in part outward of the ring mechanism housing. The tubular support post has a first end configured for contact with the substrate at the housing aperture, a second end longitudinally opposite the first end for contact with the ring mechanism housing, and a sidewall extending from the first end to the second end and having an inner surface defining a central passage through the support post. An expansible retainer comprises a head portion having a hole therethrough, and at least two flexible fingers extending longitudinally from the head portion and having an attached end at which the fingers are attached to the head portion and a free end spaced longitudinally from the head portion. The flexible fingers are arranged circumferentially about the hole in the head portion and collectively having an inner surface that together with the hole defines a central passage extending through the expansible retainer and having a cross-sectional dimension. The flexible fingers are configured such that the cross-sectional dimension of the central passage of the expansible retainer decreases in size as the fingers extend from head portion to the free end of the fingers. The flexible fingers are moveable from a relaxed condition to a deflected condition in which the fingers are deflected transversely outward relative to the relaxed condition. The fingers are sized in cross-section such that in the relaxed condition thereof the fingers are receivable through the substrate aperture and into the central passage of the support post. A generally pin-shaped expansion member has longitudinal ends and is sized in cross-section for insertion into the central passage of the expansible retainer. The cross-section of the expansion member is greater than the cross-sectional dimension of at least a portion of the central passage of the expansible retainer to urge and retains the flexible fingers transversely outward from their relaxed condition to their deflected condition in engagement with the sidewall of the support post.

In another aspect, a ring binder kit generally comprises a substrate having an aperture therein and a ring mechanism comprising a housing and two or more rings. Each ring comprises a first ring member and a second ring member and is configurable between a closed configuration in which the ring members together form a closed loop and an opened configuration in which the ring members are spaced from each other. A fastening system is configured to secure the ring mechanism to the substrate.

The fastening system comprises a tubular support post mounted on and extending at least in part through the ring mechanism housing and at least in part outward of said ring mechanism housing. The tubular support post has a first end configured for contact with the ring mechanism housing at the housing aperture, a second end longitudinally opposite the first end for contact with the ring mechanism housing, and a sidewall extending from the first end to the second end and having an inner surface defining a central passage through the support post. An expansible retainer comprises a head portion having a hole therethrough, and at least two flexible fingers extending longitudinally from the head portion and having an attached end at which the fingers are attached to the head portion and a free end spaced longitudinally from the head portion. The flexible fingers are arranged circumferentially about the hole in the head portion and collectively have an inner surface that together with the hole defines a central passage extending through the expansible retainer. The flexible fingers are moveable from a relaxed condition to a deflected condition in which the fingers are deflected transversely outward relative to the relaxed condition. The fingers are sized in cross-section such that in the relaxed condition thereof the fingers are receivable through the substrate aperture and into the central passage of the support post. The flexible fingers also collectively have an outer surface extending from the head portion to the free end of the fingers. The outer surface are smooth along the entire length of the fingers from the head portion to the free end of the fingers. A generally pin-shaped expansion member has longitudinal ends and is sized in cross-section for insertion into the central passage of the expansible retainer. The cross-section of the expansion member is greater than the cross-sectional dimension of at least a portion of the central passage of the expansible retainer to urge and retain the flexible fingers transversely outward from their relaxed condition to their deflected condition in engagement with the sidewall of the support post.

In yet another aspect, a ring binder kit further comprises a substrate having an aperture therein and a ring mechanism comprising a housing and two or more rings. Each ring comprises a first ring member and a second ring member and is configurable between a closed configuration in which the ring members together form a closed loop and an opened configuration in which the ring members are spaced from each other. A fastening system is configured to secure the ring mechanism to the substrate.

The fastening system comprises a tubular support post mounted on and extending at least in part through the ring mechanism housing and at least in part outward of the ring mechanism housing. The tubular support post has a first end configured for contact with the ring mechanism housing at the housing aperture, a second end longitudinally opposite the first end for contact with the ring mechanism housing, and a sidewall extending from the first end to the second end and having an inner surface defining a central passage through the support post. An expansible retainer comprises a head portion having a hole therethrough, and at least two flexible fingers extending longitudinally from the head portion and having an attached end at which the fingers are attached to the head portion and a free end spaced longitudinally from the head portion. The flexible fingers are arranged circumferentially about the hole in the head portion and collectively have an inner surface that together with the hole defines a central passage extending through the expansible retainer. The flexible fingers are moveable from a relaxed condition to a deflected condition in which the fingers are deflected transversely outward relative to the relaxed condition. The fingers are sized in cross-section such that in the relaxed condition thereof the fingers are receivable through the substrate aperture and into the central passage of the support post. The substrate, the support post, and the expansible retainer are configured relative to each other such that upon assembly thereof the free end of the flexible fingers is disposed within the central passage of the support post intermediate the first and second ends thereof. A generally pin-shaped expansion member has longitudinal ends and is sized in cross-section for insertion into the central passage of the expansible retainer. The cross-section is greater than the cross-sectional dimension of at least a portion of the central passage of the expansible retainer to urge and retain the flexible fingers transversely outward from their relaxed condition to their deflected condition in engagement with the sidewall of the support post.

In still a further aspect, a ring mechanism comprises a housing and two or more rings. Each ring comprises a first ring member and a second ring member and is configurable between a closed configuration in which the ring members together form a closed loop and an opened configuration in which the ring members are spaced from each other. The ring mechanism further comprises a tubular support post mounted on and extending at least in part through the ring mechanism housing and at least in part outward of the ring mechanism housing. The tubular support post has a first end configured for contact with the ring mechanism housing, a second end longitudinally opposite the first end for contact with the ring mechanism housing, and a sidewall extending from the first end to the second end and having an inner surface defining a central passage through the support post. A fastener for securing such a ring mechanism on a substrate in opposed relationship with one face of the substrate generally comprises an expansible retainer comprising a head portion configured for engagement with the opposite face of the substrate and having a hole therethrough, and at least two flexible fingers extending longitudinally from the head portion for extension through the substrate and into the central passage of the support post. The fingers have an attached end at which the fingers are attached to the head portion and a free end spaced longitudinally from the head portion. The flexible fingers are arranged circumferentially about the hole in the head portion and collectively having an inner surface that together with the hole defines a central passage extending through the expansible retainer and having a cross-sectional dimension. The flexible fingers are configured such that the cross-sectional dimension of the central passage of the expansible retainer decreases in size as the fingers extend from head portion to the free end of the fingers. The flexible fingers are moveable from a relaxed condition to a deflected condition in which the fingers are deflected transversely outward relative to the relaxed condition. A generally pin-shaped expansion member is formed separate from the expansible retainer. The expansion member has longitudinal ends and is sized in cross-section for insertion into the central passage of the expansible retainer. The cross-section is greater than the cross-sectional dimension of at least a portion of the central passage of the expansible retainer to urge and retain the flexible fingers transversely outward from their relaxed condition to their deflected condition.

### BRIEF DESCRIPTION OF THE DRAWINGS

These and other features will become apparent in connection with the description below and the figures, in which:

FIG. 1 is a fragmentary perspective view of a ring binder comprised of a cover and a ring mechanism attached to the spine of the cover, the ring mechanism being attached to the cover using one embodiment of a fastening system;

FIG. 2 is a perspective view of the underside of the ring mechanism of FIG. 1;

FIGS. 3 and 4 are perspective views of an expansible retainer and an expansion member, respectively, of the fastening system of FIG. 1;

FIGS. 5-8 are sequential assembly views, similar to the perspective view of FIG. 1 but with just the spine of the cover and the ring mechanism being illustrated;

FIGS. 9 and 10 are section views taken along the line 10-10 in FIG. 1, with FIG. 9 illustrating the ring binder fastening system half-way assembled and FIG. 10 illustrating the ring binder fastening system completely assembled.

Corresponding reference characters indicate corresponding parts throughout the several views of the drawings.

### DETAILED DESCRIPTION OF THE DRAWINGS

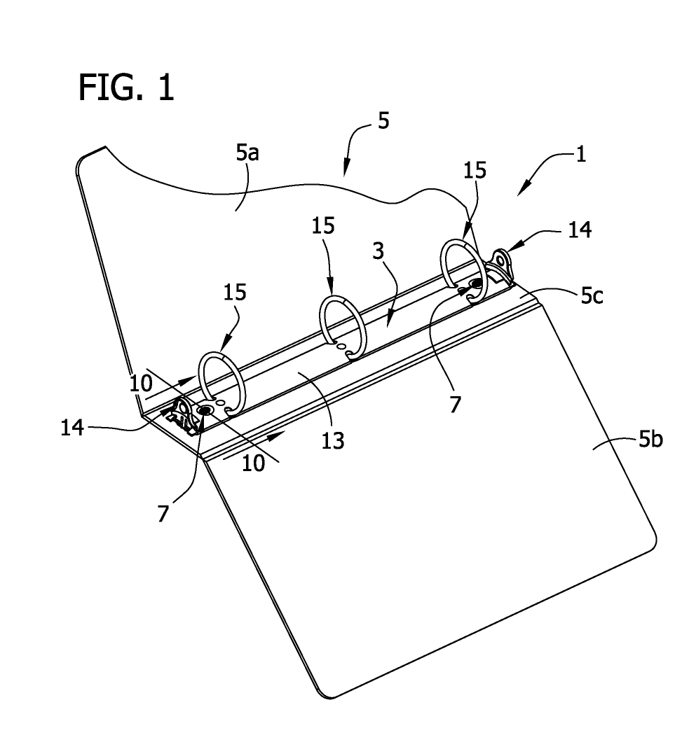

Referring now to the drawings and in particular to FIG. 1, a ring binder is designated generally by reference numeral 1. The ring binder 1 comprises a ring mechanism 3 affixed to a binder cover 5. The cover 5 has a front panel 5a, a back panel 5b, and a spine 5c. A portion of the front panel 5a is partially broken away in FIG. 1, but the front panel is substantially the same as the back panel 5b. The front and back panels 5a, 5b are hingedly attached to the spine 5c so that they can be moved to selectively cover or expose loose leaf pages (not shown) retained by the ring mechanism 3. While the ring mechanism 3 illustrated in FIGS. 1, 9, and 10 is affixed to the spine 5c of the cover 5, it should be understood that the ring mechanism could be affixed to the front or back panels 5a, 5b of the cover. Moreover, the ring mechanism 3 can be mounted on substrates other than the cover 5, such as files.

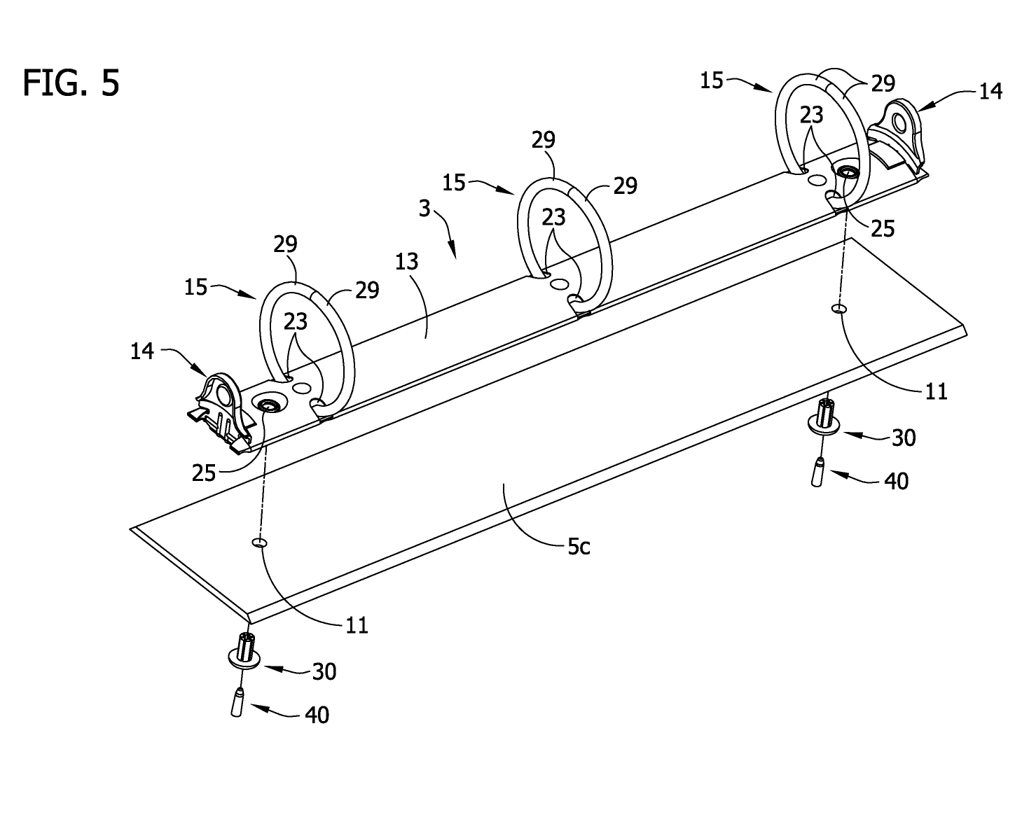

As illustrated in FIG. 5, the spine 5c of the cover has two (as shown) or more circular apertures 11 therein for use in mounting the ring mechanism 3 to the cover 5 as described in more detail below. The apertures 11 are suitably axially aligned along a central longitudinal axis of the spine 5c so that when the ring mechanism 3 is attached to the spine, a central longitudinal axis of the ring mechanism is generally parallel to the longitudinal axis of the spine.

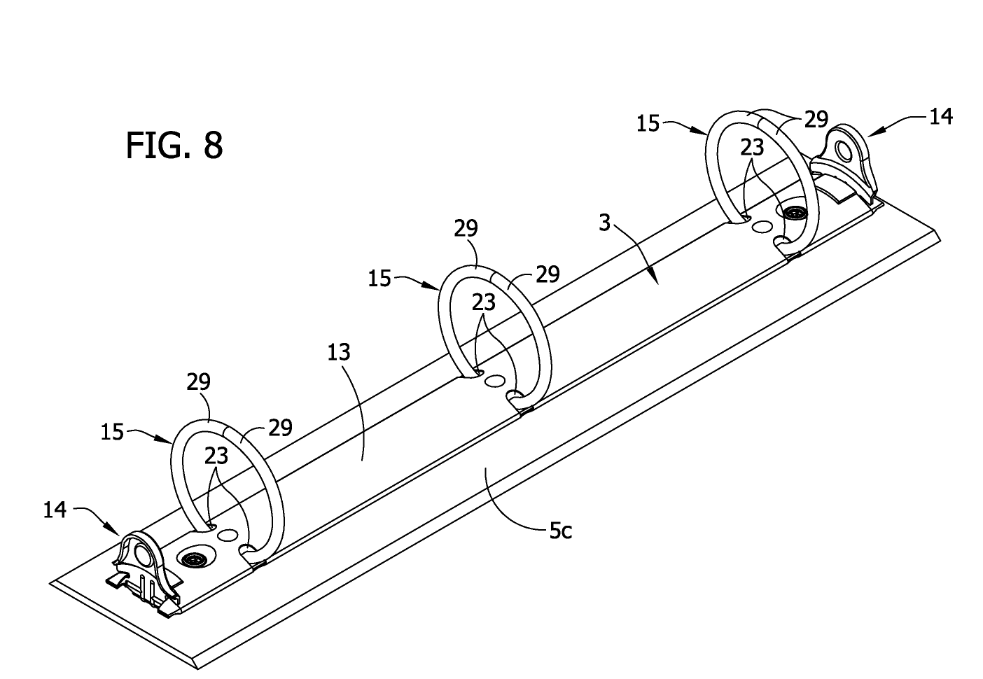

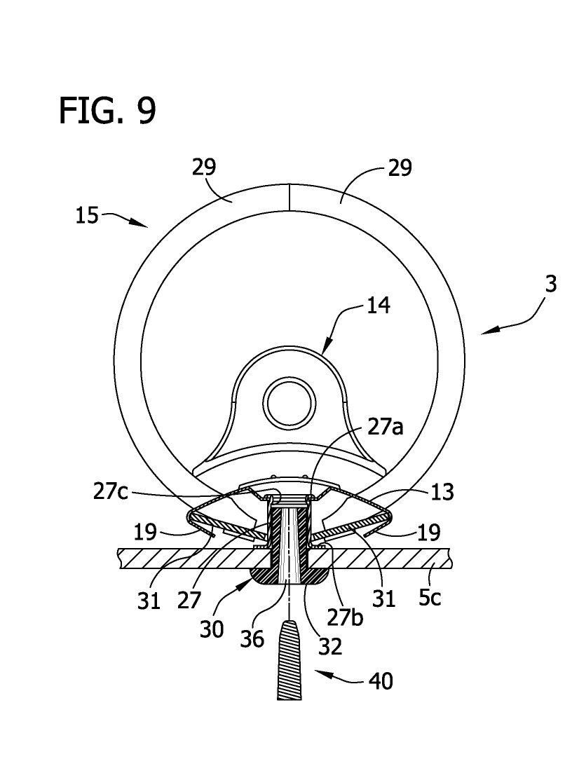

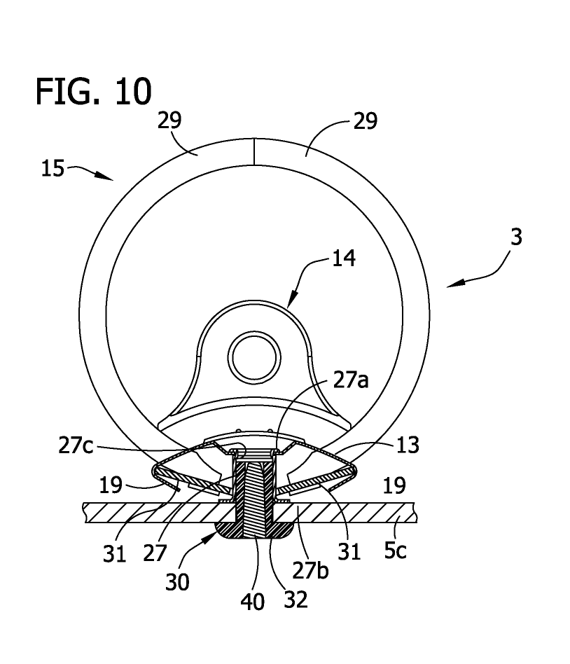

As seen in FIGS. 1, 2, and 5-10, the ring mechanism 3 comprises an elongate housing 13 that suitably supports at least one actuating lever 14 (e.g., two substantially similar actuating levers are illustrated) and at least two rings 15 (e.g., three of which are illustrated in FIG. 1). The housing 13 is symmetrical, with a roughly arch-shaped cross section (FIGS. 9 and 10), and includes two transversely opposite longitudinally extending edges and two longitudinal ends. Each lever 14 pivotally mounts on the housing 13, generally at a respective one of the longitudinal ends, for controlling movement of the rings 15 between a closed position as shown and an opened position (not illustrated).

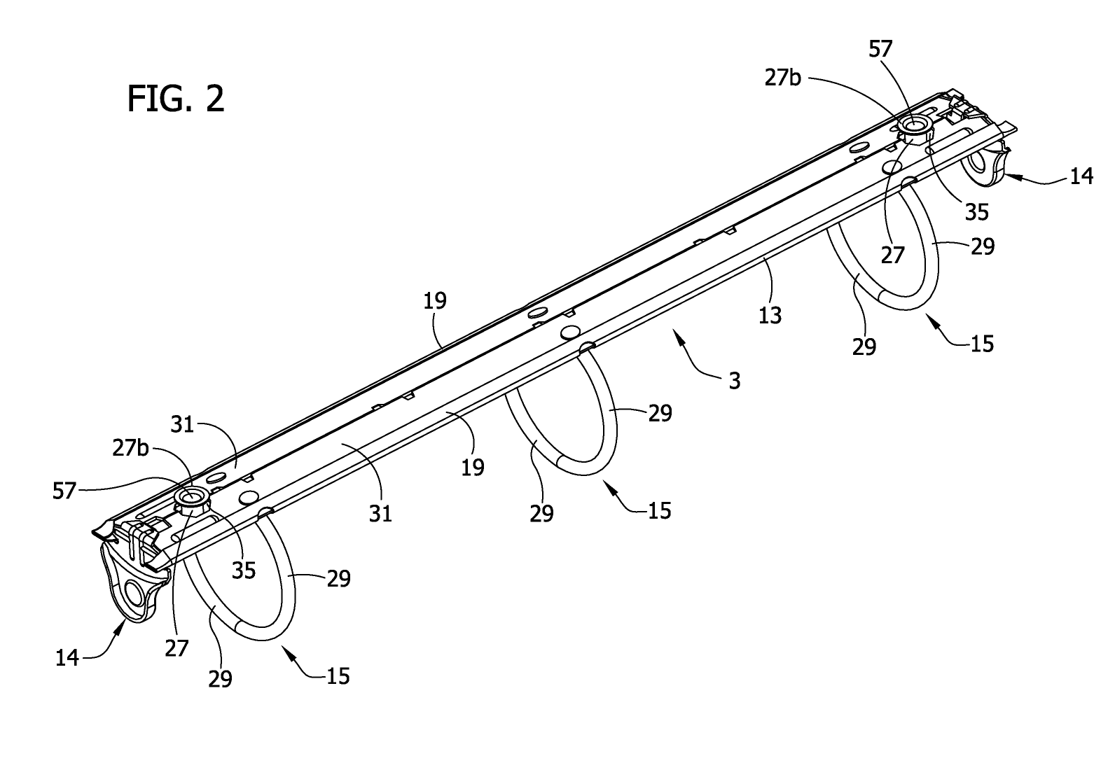

With reference to FIGS. 2, 9, and 10, a bent-under rim 19 is formed along each longitudinal edge of the housing 13 and extends the full length of the housing from one longitudinal end to the other. Six slots 23 (FIGS. 5-8) are formed in the upper wall of the housing, positioned generally adjacent to the two bent-under rims 19. The slots 23 are arranged in three transversely opposed pairs, with each pair of slots receiving one of the rings 15 therethrough and allowing each ring to move laterally relative to the housing 13 for opening and closing.

Each of the rings 15 comprises two ring members 29, which are supported by the housing 13 for movement relative to one another between the closed position (illustrated) and the opened position (not illustrated). In the closed position, the ring members 29 form a substantially continuous, closed ring or loop for retaining loose-leaf pages and for allowing the pages to move along the rings 15 from one ring member 29 to the other. In the opened position, each ring member 29 forms a discontinuous, open loop suitable for adding or removing pages. The ring members are suitably formed of a conventional, cylindrical rod of suitable material such as steel, but it should be understood that ring members having a different cross section or ring members made of different material do not depart from the scope of the present invention. Furthermore, although in the illustrated mechanism both ring members can move, mechanisms having one movable ring member and one fixed ring member do not depart from the scope of the invention. In addition, mechanisms with greater or fewer than three rings or with rings that form other shapes, such as slanted “D” shapes when the ring members are closed, do not depart from the scope of this invention.

As seen in FIGS. 9 and 10, the ring members 29 of the rings 15 are each mounted opposite to each other on one of a pair of hinge plates 31. The hinge plates are each thin and elongate and have an inner and an outer longitudinal edge margin and two longitudinal ends. Each hinge plate 31 has two (as shown in FIG. 2) or more cutouts 35, each of which is located along the inner longitudinal edge margin of the hinge plate, to accommodate two or more support posts 27 as illustrated in FIGS. 2, 9, and 10. As further seen in FIG. 2, the hinge plates 31 abut one another in parallel arrangement along their inner longitudinal edge margins, forming a central hinge having a pivot axis. The housing 13 loosely receives the outer longitudinal edge margins of the interconnected hinge plates 31 above its two bent-under rims 19. Thus, the hinge plates 31 are retained in the housing 13 while the outer longitudinal edge margins are free to move within the rims 19.

The housing 13 is slightly narrower than the joined hinge plates 31 when the hinge plates are in a coplanar position (i.e., an angle between exterior surfaces of the hinge plates is 180°). Therefore, as the hinge plates 31 pivot through this coplanar position, they deform the resilient housing 13 and cause a spring force in the housing that urges the hinge plates 31 to pivot away from the coplanar position, either closing the ring members 29 (i.e., moving the pivot axis down and away from the housing's upper wall) or opening them (i.e., moving the pivot axis up and toward the housing's upper wall). Moreover, when the ring members 29 are closed, this spring force resists hinge plate movement and clamps the ring members together. When the ring members 29 are opened the spring force holds them apart. Thus, the illustrated embodiment uses a conventional arrangement—both generally in terms of use of hinge plates and specifically in terms of use of actuating levers—to move the hinge plates 31 and ring members 29. It should be understood that other ways of moving the ring members 29 and locking them in a closed position or an opened position may be used within the scope of the present invention.

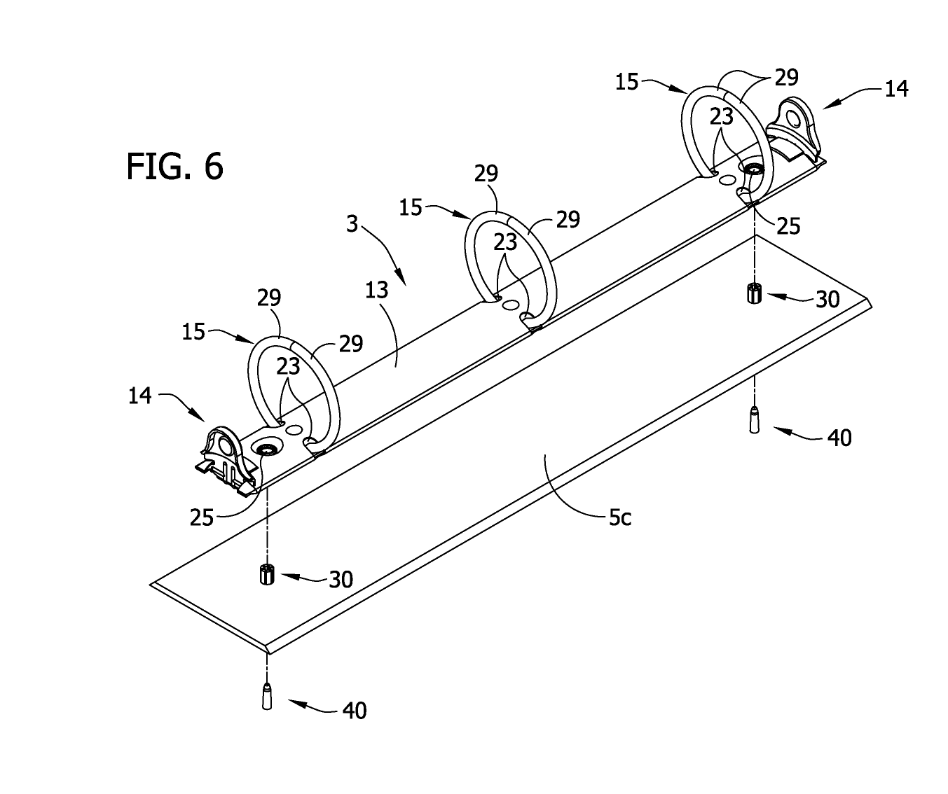

Referring to FIGS. 5 and 6, two circular openings 25 are located in the upper wall of the housing 13, generally near the longitudinal ends of the housing. Each circular opening 25 is adapted to receive and secure one of the support posts 27 to the housing 13 (see FIGS. 2, 9, and 10) for supporting the ring mechanism 3 above the spine 5c of the cover 5. As seen in FIGS. 9 and 10, the support posts 27 support and space the ring mechanism 3 from the cover 5 so that the hinge plates 31 can pivot without engaging the spine 5c. In this position, the support posts 27 are aligned with respective openings formed by the cutouts 35 of the interconnected hinge plates 31 and pass through the hinge plates without interfering with their operation. Each support post 27 is generally tubular and has two open ends, viz., a first expanded (flared) end which abuts the spine 5c and a second end by means of which the support post 27 is affixed to the housing of the ring mechanism. At the second end, each of the support posts 27 includes a deformable lip 27a that attaches the post 27 to the housing 13 adjacent one of the circular openings 25 in the upper wall of the housing 13. Each of the support posts 27 has a sidewall extending from the first end to the second end. An inner surface of the sidewall defines a central passage 27c through the support post (FIGS. 9 and 10). It should be understood that other ways of attaching the support post 27 to the housing 13 may be used. Adjacent the first end, each of the support posts 27 includes a flared foot defined by a circular rim 27b having an aperture 57 therein (FIG. 2).

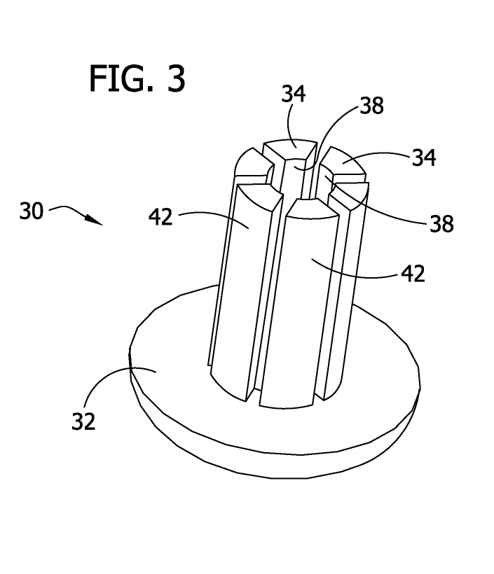

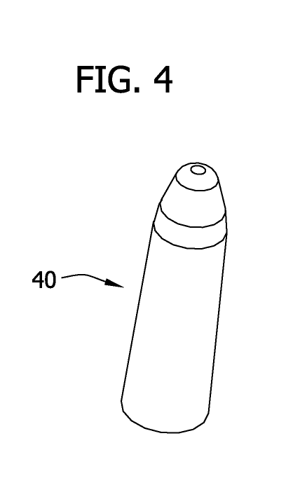

The support posts 27 constitute a first component of one embodiment of a ring mechanism fastening system; additional components being illustrated in FIGS. 3 and 4. In particular, the fastening system further comprises an expansible retainer 30 (FIG. 3) and an expansion member 40 (FIG. 4).

The expansible retainer 30 comprises a generally disc-shaped head portion 32 and at least two flexible fingers 34 (e.g., six in the illustrated embodiment) extending longitudinally from the head portion 32. A hole extends through the head portion 32, and the flexible fingers 34 are arranged around the circumference of the hole with inner walls 38 of the flexible fingers 34 generally contiguous with the walls of the hole to define a longitudinal central passage 36 through the expansible retainer 30 (FIG. 9). The flexible fingers 34 are suitably formed integral with the head portion 32, with the expansible retainer 30 being suitably formed from a relatively soft thermoplastic material so that the fingers 34 are free to flex relative to the head portion 32. When the flexible fingers 34 are relaxed (i.e., unflexed), as shown in FIGS. 3 and 9, the completely smooth (i.e., free of protuberances) outer wall surfaces 42 form a cylinder which is smaller in diameter than the inner diameter of the passage 27c through the support posts 27. Accordingly, when the flexible fingers 34 are relaxed, they fit easily within the passage 27c of the support post 27—suitably with a slight clearance fit as shown in FIG. 9.

With particular reference to FIG. 9, the inner walls 38 of the flexible fingers 34 are inclined such that the central passage 36 therethrough narrows from the hole in the head portion 32 of the expansible retainer 30 toward the free ends of the flexible fingers 34. Additionally, the length of the flexible fingers 34 is suitably limited such that when the ring mechanism 3 is joined to the spine (substrate) 5c, the flexible fingers extend to a point below the lip 27a of the support post 27, as seen in FIGS. 9 and 10. In other words, the length of the flexible fingers 34 is less than the sum of the thickness of the substrate and the length of the support posts 27 above the substrate. This feature, coupled with the fact that the flexible fingers 34 are simply straight-sided without laterally outward extending barbs, extensions, tabs, etc., at their tips, makes it easier (i.e., more efficient) to manufacture the expansible retainers 30 of the fastening system of the invention and less costly, since reduced amounts of material are used.

The expansion member 40 comprises a generally pin-shaped member. It may have straight cylindrical sides or, as in the illustrated embodiment, may suitably have slightly tapered sides which may or may not match the taper rate of the inner walls 38 of the flexible fingers 34. Furthermore, the expansion member 40 may have a tip portion that tapers (narrows) at a faster rate than the sides of the expansion member taper and, moreover, a slightly rounded endmost tip to facilitate insertion of the expansion member into the longitudinal central passage 36 through the expansible retainer 30. The relative internal and external diameters and taper rates of the expansible retainer passage 36 and the expansion member 40 are selected such that when the expansion member 40 is inserted fully into the central passage of the expansible retainer 30, as illustrated in FIG. 10, the expansion member forces the flexible fingers 34 radially outward and into contact with the inner walls of the support post 27 within the passage 27c therethrough with sufficient force so that the fastening system frictionally secures the ring mechanism 3 to the spine (substrate) 5c.

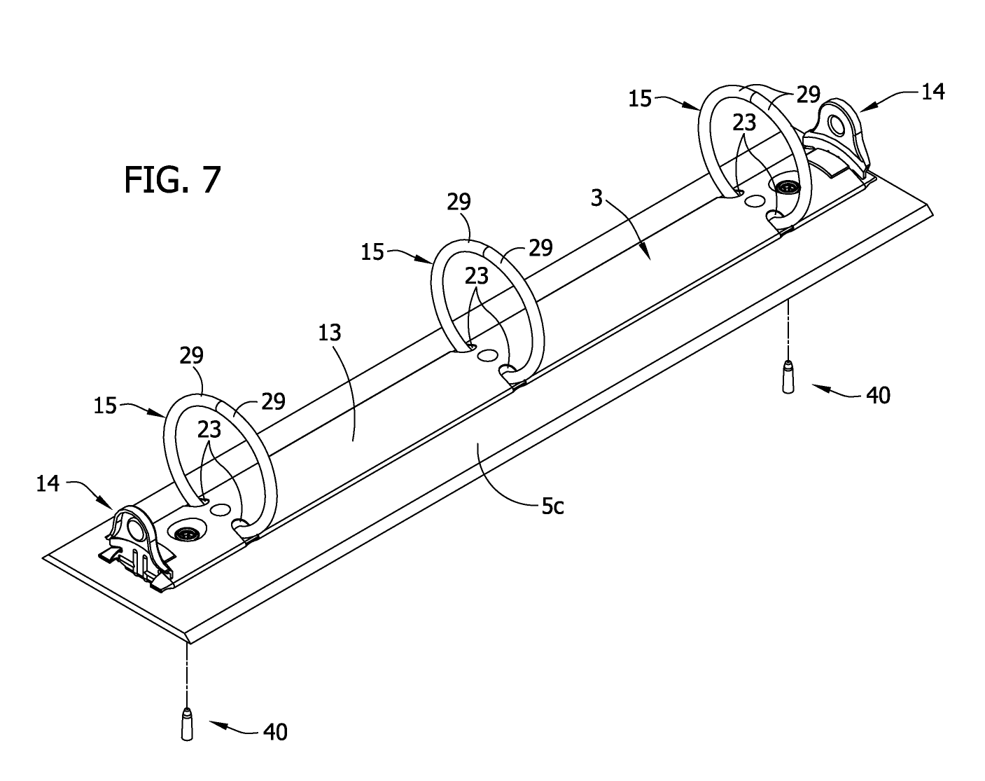

Thus, ring binders 1 can be easily assembled using the fastening system of the invention as illustrated in FIGS. 5-8. In particular, as illustrated in FIGS. 5 and 6, the flexible fingers 34 of two expansible retainers 30 are inserted through the apertures 11 in the spine 5c (or other substrate) from the side that is opposite to the side to which the ring mechanism 3 is to be attached, and the expansible retainers are inserted until the head portions 32 lie flush against the spine 5c as seen in FIGS. 9 and 10. The ring mechanism 3 is then positioned over the spine 5c, with the passages 27c through the support posts 27 (previously joined to the housing 13) aligned with the flexible fingers 34 of the expansible retainers 30, and the mechanism 3 is lowered such that the flexible fingers 34 extend into the passages in the support posts 27 and until the flared lower ends 27b of the support posts contact the spine 5c (FIG. 7). At that point, the partial assembly may be turned over, and the expansion members 40 are inserted into the expansible retainers 30. As the expansion members 40 are driven all the way into the central passages 36 of the expansible retainers 30 defined by the inner walls 38 of the flexible fingers 34, the expansion members force the flexible fingers 34 radially outward and firmly into contact with the inner walls of the passages through the support posts 27. The force of contact is sufficient to frictionally prevent the support posts from being pulled easily off of the flexible fingers. However, if necessary (e.g., to replace the cover or otherwise recycle components of the ring binder 1), the ring mechanism 3 can be pried loose mechanically from the spine 5c without excessive difficulty.

Accordingly, ring binders 1 can be packaged, shipped, stored and/or sold without having the ring mechanism 3 securely attached to the covers 5. For example, multiple covers 5 can be packaged and shipped together such that little space between adjacent covers is wasted. This can be done by laying the covers 5 flat such that the front panel 5a, back panel 5b, and spine 5c are all substantially in the same plane, and stacking others on top. The ring mechanisms 3 and fasteners can be packaged in the same container as the covers 5, or separately. Either way, the ring mechanism 3 can also be arranged to minimize wasted space. One possible packing arrangement for the ring mechanisms 3 is to pack them in alternating directions such that the rings 15 of one mechanism are positioned between the rings of an adjacent mechanism. As a result, the separated covers 5 and ring mechanisms 3 can be packaged, shipped, and stored more efficiently and cost effectively than ring binders having the ring mechanisms attached.

The ring mechanisms 3 can be attached to the covers 5, for example, by the retailer before distribution to a customer (i.e, after a sale) or before placing them on display. It is also understood that the customer may wish to maintain the ring mechanisms 3 and covers 5 separate to take advantage of the saved storage space. Thus, the customer may be the one who attaches the ring mechanism 3 to the cover 5. Accordingly, it is understood that the ring mechanism and cover can be joined to form a ring binder at any of various times. The examples of the ring mechanism being attached to the cover by a retailer and a customer are exemplary only as it is understood that other individuals, including the ring binder manufacturer, may assemble the ring binder.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “forward” and “rearward” and variations of these terms, or the use of other directional and orientation terms, is made for convenience, but does not require any particular orientation of the components.

As various changes could be made in the above without departing from the scope of the invention, it is intended that all matter contained in the above description and illustrated in the accompanying drawings shall be interpreted as illustrative and not in a limiting sense.

What is claimed is:

1. A ring binder kit comprising:
a substrate having an aperture therein;
a ring mechanism comprising a housing and two or more rings, each ring comprising a first ring member and a second ring member and being configurable between a closed configuration in which the ring members together form a closed loop and an opened configuration in which the ring members are spaced from each other; and
a fastening system configured to secure said ring mechanism to said substrate, said fastening system comprising:
a tubular support post mounted on and extending at least in part through said ring mechanism housing and at least in part outward of said ring mechanism housing, said tubular support post having a first end configured for contact with the substrate at said housing aperture, a second end longitudinally opposite the first end for contact with the ring mechanism housing, and a sidewall extending from said first end to said second end and having an inner surface defining a central passage through said support post;
an expansible retainer comprising a head portion having a hole therethrough, and at least two flexible fingers extending longitudinally from the head portion and having an attached end at which the fingers are attached to the head portion and a free end spaced longitudinally from the head portion, the flexible fingers being arranged circumferentially about the hole in said head portion and collectively having an inner surface that together with said hole defines a central passage extending through the expansible retainer and having a cross-sectional dimension, the flexible fingers being configured such that the cross-sectional dimension of the central passage of the expansible retainer decreases in size as the fingers extend from head portion to the free end of the fingers, said flexible fingers being moveable from a relaxed condition to a deflected condition in which the fingers are deflected transversely outward relative to the relaxed condition, the fingers being sized in cross-section such that in the relaxed condition thereof the fingers are receivable through the substrate aperture and into the central passage of said support post; and
a generally pin-shaped expansion member having longitudinal ends and being sized in cross-section for insertion into the central passage of the expansible retainer, said cross-section being greater than the cross-sectional dimension of at least a portion of the central passage of the expansible retainer to urge and retain the flexible fingers transversely outward from their relaxed condition to their deflected condition in engagement with the sidewall of the support post.

2. The ring binder kit of claim 1, wherein the flexible fingers also collectively define an outer surface extending from said head portion to said free end of said fingers, said outer surface being smooth along the entire length of the fingers from said head portion to the free end of the fingers.

3. The ring binder kit of claim 1, wherein the flexible fingers also collectively define an outer surface extending from said head portion of the retainer to said free end of said fingers, said outer surface defining an outer cross-section dimension of the fingers, said outer cross-sectional dimension being uniform along the length of the fingers from said retainer head portion to said free end of said fingers.

4. The ring binder kit of claim 3, wherein said outer surface is generally cylindrical.

5. The ring binder kit of claim 1, wherein the substrate, the support post, and the expansible retainer are configured relative to each other such that upon assembly thereof the free end of the flexible fingers is disposed within the central passage of the support post intermediate the first and second ends thereof.

6. The ring binder kit of claim 1, wherein the cross-sectional dimension of the expansion member is non-uniform.

7. The ring binder kit of claim 6, wherein the expansion member has a main portion and a tapered tip, the cross-sectional dimension of the expansion member decreasing at a first rate along said main portion and at a second rate greater than said first rate along said tapered tip.

8. The ring binder kit of claim 7, wherein the tapered tip is rounded off at one of the longitudinal ends of the expansion member.

9. The ring binder kit of claim 1, wherein said substrate comprises a ring binder cover.

10. The ring binder kit of claim 1, wherein in the deflected condition of the flexible fingers of said expansible retainer the flexible fingers frictionally engage the sidewall of the support post to inhibit removal of the retainer from the support post.

11. A ring binder kit comprising:
a substrate having an aperture therein;
a ring mechanism comprising a housing and two or more rings, each ring comprising a first ring member and a second ring member and being configurable between a closed configuration in which the ring members together form a closed loop and an opened configuration in which the ring members are spaced from each other; and
a fastening system configured to secure said ring mechanism to said substrate, said fastening system comprising:
a tubular support post mounted on and extending at least in part through said ring mechanism housing and at least in part outward of said ring mechanism housing, said tubular support post having a first end configured for contact with the ring mechanism housing at said housing aperture, a second end longitudinally opposite the first end for contact with the ring mechanism housing, and a sidewall extending from said first end to said second end and having an inner surface defining a central passage through said support post;
an expansible retainer comprising a head portion having a hole therethrough, and at least two flexible fingers extending longitudinally from the head portion and having an attached end at which the fingers are attached to the head portion and a free end spaced longitudinally from the head portion, the flexible fingers being arranged circumferentially about the hole in said head portion and collectively having an inner surface that together with said hole defines a central passage extending through the expansible retainer, the flexible fingers being moveable from a relaxed condition to a deflected condition in which the fingers are deflected transversely outward relative to the relaxed condition, the fingers being sized in cross-section such that in the relaxed condition thereof the fingers are receivable through the substrate aperture and into the central passage of said support post, the flexible fingers also collectively having an outer surface extending from said head portion to said free end of said fingers, said outer surface being smooth along the entire length of the fingers from said head portion to said free end of the fingers; and
a generally pin-shaped expansion member having longitudinal ends and being sized in cross-section for insertion into the central passage of the expansible retainer, said cross-section being greater than the cross-sectional dimension of at least a portion of the central passage of the expansible retainer to urge and retain the flexible fingers transversely outward from their relaxed condition to their deflected condition in engagement with the sidewall of the support post.

12. The ring binder kit of claim 11, wherein the outer surface of the flexible fingers defines an outer cross-sectional dimension thereof, said outer cross-section dimension being uniform along the length of the fingers from said retainer head portion to said free end of said fingers.

13. The ring binder kit of claim 12, wherein said outer surface is generally cylindrical.

14. The ring binder kit of claim 11, wherein the substrate, the support post, and the expansible retainer are configured relative to each other such that upon assembly thereof the free end of the flexible fingers is disposed within the central passage of the support post intermediate the first and second ends thereof.

15. The ring binder kit of claim 11, wherein the cross-sectional dimension of the expansion member is non-uniform along the length thereof.

16. The ring binder kit of claim 15, wherein the expansion member has a main portion and a tapered tip, the cross-sectional dimension of the expansion member decreasing at a first rate along said main portion and at a second rate greater than said first rate along said tapered tip.

17. The ring binder kit of claim 15, wherein the tapered tip is rounded off at one of the longitudinal ends of the expansion member.

18. The ring binder kit of claim 11, wherein said substrate comprises a ring binder cover.

19. A ring binder kit comprising:
a substrate having an aperture therein;
a ring mechanism comprising a housing and two or more rings, each ring comprising a first ring member and a second ring member and being configurable between a closed configuration in which the ring members together form a closed loop and an opened configuration in which the ring members are spaced from each other; and
a fastening system configured to secure said ring mechanism to said substrate, said fastening system comprising:
a tubular support post mounted on and extending at least in part through said ring mechanism housing and at least in part outward of said ring mechanism housing, said tubular support post having a first end configured for contact with the ring mechanism housing at said housing aperture, a second end longitudinally opposite the first end for contact with the ring mechanism housing, and a sidewall extending from said first end to said second end and having an inner surface defining a central passage through said support post;
an expansible retainer comprising a head portion having a hole therethrough, and at least two flexible fingers extending longitudinally from the head portion and having an attached end at which the fingers are attached to the head portion and a free end spaced longitudinally from the head portion, the flexible fingers being arranged circumferentially about the hole in said head portion and collectively having an inner surface that together with said hole defines a central passage extending through the expansible retainer, the flexible fingers being moveable from a relaxed condition to a deflected condition in which the fingers are deflected transversely outward relative to the relaxed condition, the fingers being sized in cross-section such that in the relaxed condition thereof the fingers are receivable through the substrate aperture and into the central passage of said support post, the substrate, the support post, and the expansible retainer being configured relative to each other such that upon assembly thereof the free end of the flexible fingers is disposed within the central passage of the support post intermediate the first and second ends thereof; and
a generally pin-shaped expansion member having longitudinal ends and being sized in cross-section for insertion into the central passage of the expansible retainer, said cross-section being greater than the cross-sectional dimension of at least a portion of the central passage of the expansible retainer to urge and retain the flexible fingers transversely outward from their relaxed condition to their deflected condition in engagement with the sidewall of the support post.

20. A fastener for securing a ring mechanism on a substrate in opposed relationship with one face of the substrate, the substrate having an opposite face, the ring mechanism comprising a housing and two or more rings, each ring comprising a first ring member and a second ring member and being configurable between a closed configuration in which the ring members together form a closed loop and an opened configuration in which the ring members are spaced from each other, the ring mechanism further comprising a tubular support post mounted on and extending at least in part through said ring mechanism housing and at least in part outward of said ring mechanism housing, said tubular support post having a first end configured for contact with the ring mechanism housing, a second end longitudinally opposite the first end for contact with the ring mechanism housing, and a sidewall extending from said first end to said second end and having an inner surface defining a central passage through said support post, the fastener comprising:
an expansible retainer comprising a head portion configured for engagement with the opposite face of the substrate and having a hole therethrough, and at least two flexible fingers extending longitudinally from the head portion for extension through the substrate and into the central passage of the support post, the fingers having an attached end at which the fingers are attached to the head portion and a free end spaced longitudinally from the head portion, said flexible fingers being arranged circumferentially about the hole in said head portion and collectively having an inner surface that together with said hole defines a central passage extending through the expansible retainer and having a cross-sectional dimension, the flexible fingers being configured such that the cross-sectional dimension of the central passage of the expansible retainer decreases in size as the fingers extend from head portion to the free end of the fingers, said flexible fingers being moveable from a relaxed condition to a deflected condition in which the fingers are deflected transversely outward relative to the relaxed condition; and
a generally pin-shaped expansion member formed separate from the expansible retainer, the expansion member having longitudinal ends and being sized in cross-section for insertion into the central passage of the expansible retainer, said cross-section being greater than the cross-sectional dimension of at least a portion of the central passage of the expansible retainer to urge and retain the flexible fingers transversely outward from their relaxed condition to their deflected condition.
